(19) United States
(12) Patent Application Publication
(10) Pub. No.: US 2026/0231289 A1
(43) Pub. Date: Aug. 6, 2026

(54) TERMINAL APPARATUS, BASE STATION APPARATUS, AND COMPUTER-IMPLEMENTED CONTROL METHOD FOR TERMINAL APPARATUS

(71) Applicant: 1FINITY Inc., Kawasaki-shi Kanagawa (JP)

(72) Inventors: Katsunari UEMURA, Chiba (JP); Huiting Cheng, Yokohama (JP)

(73) Assignee: 1FINITY Inc., Kawasaki-shi Kanagawa (JP)

(21) Appl. No.: 19/532,278

(22) Filed: Feb. 6, 2026

Related U.S. Application Data
(63) Continuation of application No. PCT/JP2023/028992, filed on Aug. 8, 2023.

(51) Int. Cl. H04W 76/28; H04W 72/231; H04W 72/51

(52) U.S. Cl. CPC H04W 76/28; H04W 72/231; H04W 72/51

(57) ABSTRACT

A terminal apparatus includes: a receiver configured to receive first information regarding configuration of a first period, and second information regarding configuration of a second period, and a controller configured to control transmission and reception in accordance with the first period and the second period, wherein the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and the controller performs processing of receiving retransmission of downlink data in accordance with the first configuration and the configuration of the second period, in a case where the first configuration is configured and activated and the second period is configured.

### CROSS-REFERENCE TO RELATED APPLICATION

This application is based upon and claims the benefit of priority of the prior International Application No. PCT/JP2023/028992, filed on August 8, 2023, the entire contents of which are incorporated herein by reference.

### FIELD

The present embodiment relates to a terminal apparatus, a base station apparatus, and a computer-implemented control method for a terminal apparatus.

### BACKGROUND

In the 3rd generation partnership project (3GPP) (Registered trademark), which is a standardization project, as New Radio (also referred to as “5G”), which is the fifth generation mobile communication, technical specifications of communication standards that satisfy requirements of enhanced mobile broadband (eMBB), massive machine type communications (MTC), and ultra-reliable and low latency communication (URLLC) have been studied.

In 3GPP, a technology for network energy savings (NES) has been studied to reduce power consumption on a network side (that is, a base station apparatus and core network equipment) (Non Patent Document 1).

As one of technologies in the NES, Cell DTX/DRX for realizing discontinuous reception (DRX) and/or discontinuous transmission (DTX) in a cell-basis has been studied. Cell DTX/DRX is a technology in which a base station apparatus configures an active period and an inactive period or a non-active period in units of cells, and the base station apparatus performs transmission and reception only in the active period and restricts transmission and reception in the inactive period, thereby reducing power consumption (Non Patent Documents 1 and 2).

For example, related arts are disclosed in 3GPP TR 38.864 V18.0.0(2022-12) (Non Patent Document 1) and R2-2305651 (Non Patent Document 2).

### SUMMARY

According to an aspect of the embodiments, a terminal apparatus that communicates with a base station apparatus, the terminal apparatus including a receiver configured to receive, from the base station apparatus, first information regarding configuration of a first period indicating a period in which transmission and reception are possible on a cell basis, and second information regarding configuration of a second period indicating a period of discontinuous reception of the terminal apparatus, and a controller configured to control transmission and reception in accordance with the first period and the second period, wherein the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and the controller performs processing of receiving retransmission of downlink data in accordance with the first configuration and the configuration of the second period, in a case where the first configuration is configured and activated and the second period is configured.

According to an aspect of the embodiments, a base station apparatus that communicates with a terminal apparatus, the base station apparatus including a transmitter configured to transmit, to the terminal apparatus, first information regarding configuration of a first period indicating a period in which transmission and reception are possible on a cell basis, and second information regarding configuration of a second period indicating a period of discontinuous reception of the terminal apparatus, and a controller configured to control transmission and reception in accordance with the first period and the second period, wherein the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and the controller performs retransmission processing of downlink data in accordance with the first configuration and the configuration of the second period, in a case where the first configuration is configured and activated and the second period is configured.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating an example of a configuration of a radio communication system according to an embodiment;

FIG. 2 is a diagram illustrating an example of a functional configuration of a terminal apparatus according to the embodiment;

FIG. 3 is a diagram illustrating an example of a functional configuration of a base station apparatus according to the embodiment;

FIG. 4 is a diagram illustrating an example of a control method for an active period according to Cell DTX;

FIG. 5 is a diagram illustrating an example of a control method for an active period according to Cell DRX;

FIG. 6 is a diagram illustrating another example of the control method of the active period in a case where Cell DTX or Cell DRX is configured;

FIG. 7 is a diagram illustrating an example of a determination method for retransmission control of a terminal apparatus;

FIG. 8 is a diagram illustrating another example of a determination method for retransmission control of a terminal apparatus;

FIG. 9 is a diagram illustrating an example of a control method of an active period and an inactive period of the terminal apparatus;

FIG. 10 is a diagram illustrating an example of a control method of the active period and the inactive period related to downlink data reception by the terminal apparatus;

FIG. 11 is a diagram illustrating an example of a control method of the active period and the inactive period related to uplink data transmission by the terminal apparatus;

FIG. 12 is a diagram illustrating an example of a hardware configuration of the terminal apparatus; and

FIG. 13 is a diagram illustrating an example of a hardware configuration of the base station apparatus.

### DESCRIPTION OF EMBODIMENTS

By applying Cell DTX/DRX, the base station apparatus can obtain a power saving effect, but when unexpected transmission and reception of data occurs at the terminal apparatus and scheduling is not completed within the active period of Cell DTX/DRX, transmission and reception of the remaining data need to wait for scheduling in the next active period. This has a problem that, for example, in a case where the generated data is time-sensitive data or data requiring low latency, the quality of service (QoS) requirement is not satisfied, leading to degradation in user experience.

Therefore, a method has been proposed in which the base station apparatus performs scheduling for the terminal apparatus even during an inactive period of Cell DTX/DRX, if the period is a retransmission-possible period of the data. In other words, a method has been proposed in which, when a retransmission timer configured in the terminal apparatus is running, a physical downlink control channel PDCCH that instructs scheduling of retransmission data is received (monitored) (Non Patent Document 2).

However, the method described in Non Patent Document 2 takes into consideration only a case where a retransmission timer in the terminal apparatus is running, and is not applied in a case where the retransmission timer is not configured in the terminal apparatus, that is, in a case where only the configuration related to Cell DTX/DRX is notified to the terminal apparatus, which may result in a failure to satisfy QoS or the like.

Hereinafter, present embodiments will be described in detail with reference to the drawings. Problems and embodiments in the present specification are merely examples, and do not limit the scope of rights of the present application. In particular, the technology of the present application can be applied to even different expressions as long as the expressions are technically equivalent, and the scope of rights is not limited. The embodiments can be appropriately combined within a range in which the processing contents do not contradict each other. For example, the inactive period may be referred to as a non-active period.

A known technology may be appropriately used in a radio communication system according to the present embodiments. The applicable known technology may be, for example, 5G (NR), Beyond 5G, 5G-Advanced, or other radio communication methods. The radio communication system according to the present embodiments is applicable to NR, but is not limited thereto. For example, the present embodiments are also applicable to Long Term Evolution (LTE) and LTE-Advanced. Further, the present embodiment is also applicable to a radio communication system using NR as a part of the radio communication system.

Further, the present embodiments are applicable to any radio communication system including at least a terminal apparatus and a base station apparatus, and are also applicable to future radio communication systems. In the following description, LTE and LTE-Advanced are also referred to as evolved universal terrestrial radio access (E-UTRA), but the meanings thereof are the same.

Embodiments of a base station apparatus, a terminal apparatus, and a radio communication system disclosed in the present application will be described below with reference to the drawings. Note that the following embodiments do not limit the disclosed technology.

### Radio Communication System

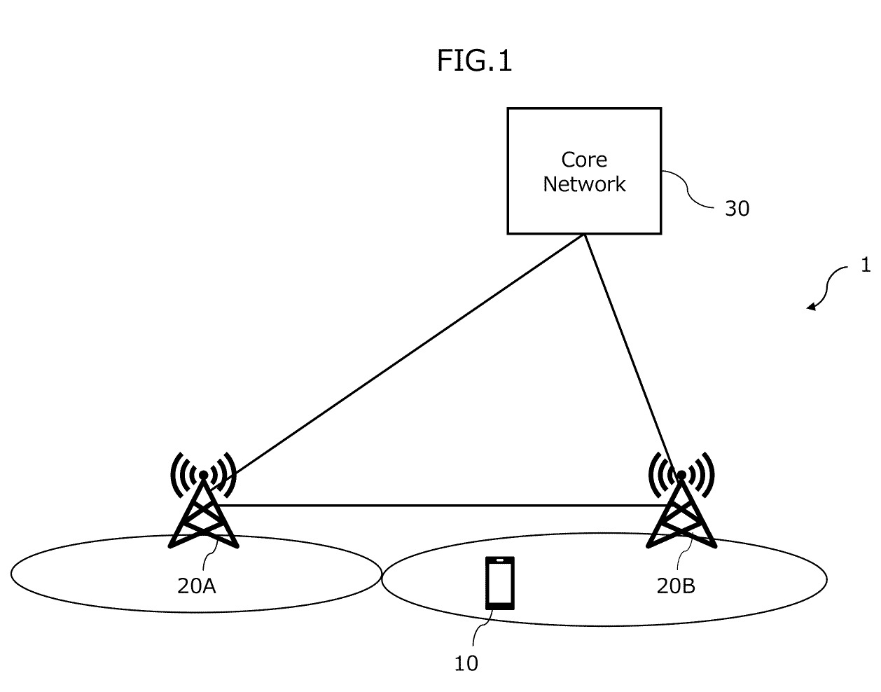

FIG. 1 is a diagram illustrating an example of a configuration of a radio communication system 1 according to present embodiments. The radio communication system 1 according to the embodiment includes, for example, a terminal apparatus 10, base station apparatuses 20A and 20B, and a core network 30. Note that, in a case where the base station apparatuses 20A and 20B are not distinguished, they are simply referred to as a base station apparatus 20. Furthermore, a plurality of terminal apparatuses 10 may be provided.

The terminal apparatus 10 may be, for example, a wireless terminal such as various apparatuses and equipment (such as sensor devices) having a radio communication function, such as a mobile phone, a smartphone, a personal digital assistant (PDA), a tablet, a wearable terminal, a personal computer, and a vehicle. Furthermore, the terminal apparatus 10 may be referred to as a radio communication apparatus, a communication apparatus, a reception apparatus, a mobile station, a User Equipment (UE), a user apparatus, or the like.

A radio communication service is provided to the terminal apparatus 10 by the base station apparatus 20 and the core network 30 in the radio communication system 1. The core network 30 has functions such as management of service subscriber information, session management for a voice call, and location registration management of the terminal apparatus 10, for example. In addition, the core network 30 transmits control data and/or user data to the terminal apparatus 10 via the base station apparatus 20.

The core network 30 may be a 5G core (5GC) in 5G (NR) or an Evolved Packet Core (EPC) in 4G (E-UTRA). Furthermore, a method for connection between the core network 30 and the base station apparatus 20 may be a Non-Stand Alone (NSA) method or a Stand Alone (SA) method.

The 5G base station apparatus 20 connected to the 5GC is a gNB, and the 4G base station apparatus 20 connected to the EPC is an eNB. In addition, 5G base station apparatuses are connected by an Xn interface, and 4G base station apparatuses are connected by an X2 interface.

An area (coverage area) formed by the base station apparatus 20 may be referred to as a “cell”. E-UTRA and 5G are cellular communication systems constructed by a plurality of cells. As the radio communication system 1 according to the present embodiments, either a Time Division Duplex (TDD) scheme or a Frequency Division Duplex (FDD) scheme may be applied, or a different scheme may be applied for each cell.

The base station apparatus 20 may be divided into, for example, a Centralized Unit (CU), a Distributed Unit (DU), and a Radio Unit (RU). The CU is connected to the core network. The DU is connected to the terminal apparatus 10 via, for example, the RU. The DU and the RU may be integrated, and in this case, the DU is connected to the terminal apparatus 10. A communication path between the CU and the DU is implemented by, for example, a fronthaul interface (F1 interface). Further, a configuration may be adopted in which a plurality of DUs are connected to a single CU.

In the example illustrated in FIG. 1, data (downlink data, DL data) transmitted from the core network 30 to the terminal apparatus 10 is transmitted from the core network 30 to the base station apparatus 20, and is transmitted (transferred) from the base station apparatus 20 to the terminal apparatus 10.

Data (uplink data, UL data) transmitted from the terminal apparatus 10 to the core network 30 is transmitted from the terminal apparatus 10 to the base station apparatus 20, and is transmitted (transferred) from the base station apparatus 20 to the core network 30.

The terminal apparatus 10 and the base station apparatus 20 transmit and receive a radio resource control (RRC) message (also referred to as RRC signaling) in an RRC layer. In addition, the terminal apparatus 10 and the base station apparatus 20 transmit and receive a medium access control (MAC) control element (MAC CE) in a MAC layer.

The RRC message is transmitted as a RRC protocol data unit (RRC PDU), and a common control channel (CCCH), a dedicated control channel (DCCH), a paging control channel (PCCH), a broadcast control channel (BCCH), a multicast control channel (MCCH), or the like is used as a logical channel (LCH) to be mapped.

The MAC CE is transmitted as a MAC PDU (or a MAC subPDU). The MAC subPDU is equivalent to a service data unit (SDU) in the MAC layer with, for example, an 8-bit header, and the MAC PDU includes one or more MAC subPDUs.

Subsequently, as the physical channel and the physical signal according to the embodiment, at least a synchronization signal (Primary Synchronization Signal, Secondary Synchronization Signal), a physical broadcast channel (PBCH), a physical random access channel (PRACH), a physical downlink control channel (PDCCH), a channel state information-reference signal (CSI-RS), a physical uplink control channel (PUCCH), a physical downlink shared channel (PDSCH), a physical uplink shared channel (PUSCH), a scheduling reference signal (SRS), and a demodulation reference signal (DMRS) are present, but detailed description thereof is omitted.

### Terminal Apparatus

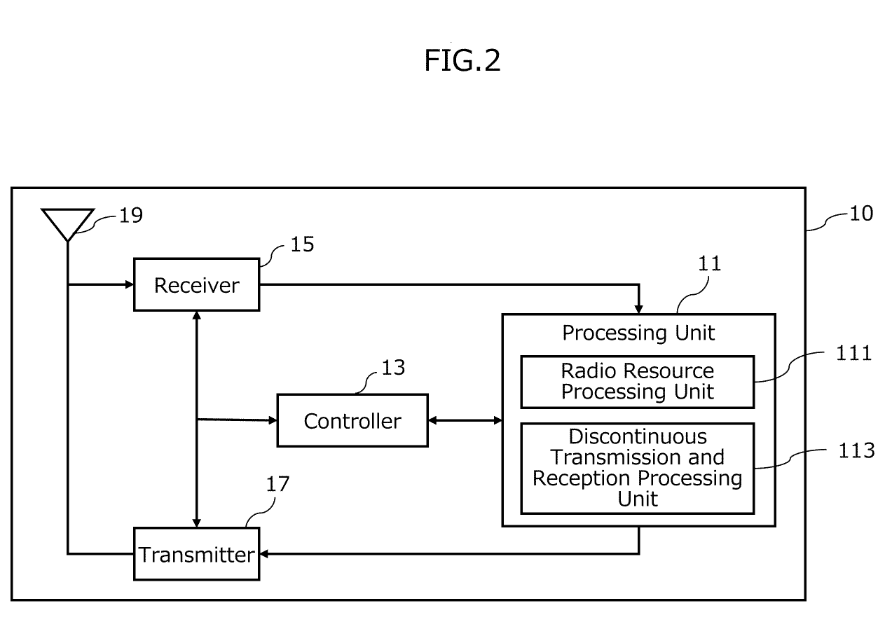

FIG. 2 is a diagram illustrating an example of a functional configuration of the terminal apparatus 10 according to the embodiment. As illustrated in FIG. 2, the terminal apparatus 10 includes, for example, a processing unit 11, a controller 13, a receiver 15, a transmitter 17, and a transmission and reception antenna unit 19. The processing unit 11 includes, for example, a radio resource processing unit 111 and a discontinuous transmission and reception processing unit 113. Note that the functional configuration of the terminal apparatus 10 illustrated in FIG. 2 is merely an example, and functional categories and names of functional blocks may be different as long as the operation according to the embodiment can be performed. Alternatively, one or more blocks that implement other functions may also be present.

The processing unit 11 generates, for example, control information for controlling the receiver 15 and the transmitter 17, and outputs the control information to the controller 13. The processing unit 11 executes processing related to, for example, a radio resource control layer, a packet data convergence protocol (PDCP) layer, a radio link control (RLC) layer, and a medium access control layer.

The radio resource processing unit 111 manages various types of configuration information (RRC parameter and information element (IE)) of the terminal apparatus 10. For example, the radio resource processing unit 111 generates information to be placed on each physical uplink channel, and outputs the information to the transmitter 17. In addition, the radio resource processing unit 111 performs measurement of the serving cell and the neighboring cell, start and stop of transmission and reception processing, a DL synchronization procedure (cell search), a UL synchronization procedure (random access procedure), reacquisition of system information, event evaluation regarding handover, a series of processing related to handover, and the like based on an instruction from the base station apparatus 20.

The discontinuous transmission and reception processing unit 113 executes a series of control processing related to discontinuous reception (DRX) and discontinuous transmission (DTX). For example, the discontinuous transmission and reception processing unit 113 manages, based on an instruction from the radio resource processing unit 111 or an instruction from the base station apparatus 20, a plurality of timers related to discontinuous reception (DRX) and discontinuous transmission (DTX), and executes a series of transmission and reception processing of the terminal apparatus 10 in the active period or the inactive period. The discontinuous transmission and reception processing unit 113 executes timing processing of a timer related to Cell DTX/DRX associated with discontinuous transmission and reception of the base station apparatus 20, and a timer related to DRX (C-DRX: Connected mode DRX) associated with discontinuous transmission and reception of the connected terminal apparatus 10, control for coordination among the respective timers, and determination processing regarding whether transmission or reception of the terminal apparatus 10 is permitted, based on a coordination result.

The controller 13 performs various types of control in the terminal apparatus 10. For example, the controller 13 generates a control signal or control data for controlling the receiver 15 and the transmitter 17 based on the control information received from the processing unit 11. In addition, the controller 13 controls uplink transmission to the base station apparatus 20 and downlink reception from the base station apparatus 20, respectively, based on determination information related to discontinuous transmission and reception from the discontinuous transmission and reception processing unit 113.

The receiver 15 separates, demodulates, and decodes various signals received from the base station apparatus 20 via the transmission and reception antenna unit 19 based on the control signal provided from the controller 13. The receiver 15 outputs decoded information to the processing unit 11.

The transmitter 17 generates, for example, a physical uplink signal based on the control signal provided from the controller 13, and performs encoding, modulation, and the like on the physical uplink signal or the physical uplink channel provided from the processing unit 11. The transmitter 17 multiplexes various signals and transmits the multiplexed signal to the base station apparatus 20 via the transmission and reception antenna unit 19.

Note that the processing unit 11 and the controller 13 are implemented by, for example, a processor system including a processor and a memory. In this case, the processor provides the functions of the processing unit 11 and the controller 13 by executing a program describing an operation of the terminal apparatus 10 described below. In addition, the processing unit 11 and the controller 13 may be implemented by one processor system or may be implemented by a plurality of processor systems. Alternatively, the processing unit 11 and the c controller 13 may be implemented by a digital signal processor (DSP), a hardware circuit, or the like.

### Base Station Apparatus

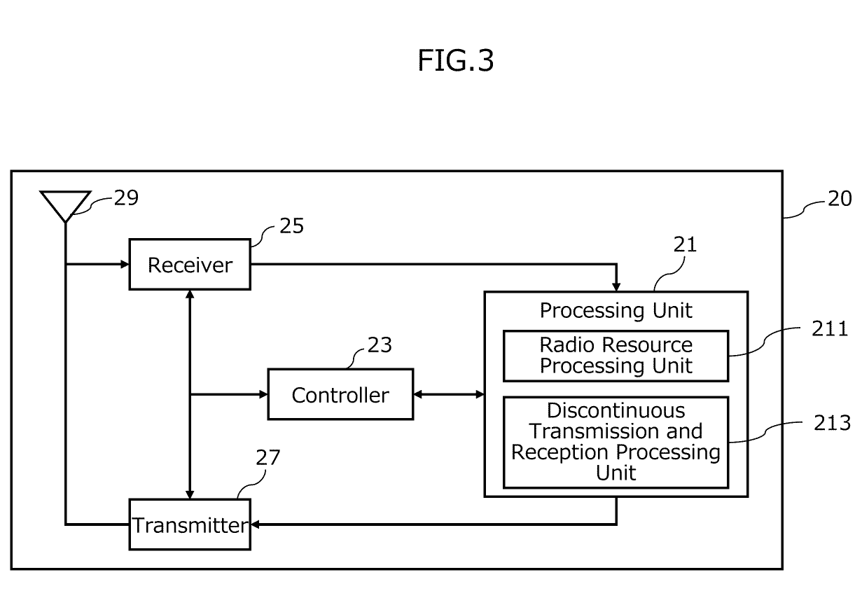

FIG. 3 is a diagram illustrating an example of a functional configuration of the base station apparatus 20 according to an embodiment. As illustrated in FIG. 3, the base station apparatus 20 includes, for example, a processing unit 21, a controller 23, a receiver 25, a transmitter 27, and a transmission and reception antenna unit 29. The processing unit 21 includes, for example, a radio resource processing unit 211 and a discontinuous transmission and reception processing unit 213. Note that the functional configuration of the base station apparatus 20 illustrated in FIG. 3 is merely an example, and functional categories and names of functional blocks may be different as long as the operation according to the embodiment can be performed. Alternatively, one or more blocks that implement other functions may also be present.

The processing unit 21 generates, for example, control information for controlling the receiver 25 and the transmitter 27, and outputs the control information to the controller 23. The processing unit 21 executes processing related to, for example, a radio resource control layer, a packet data convergence protocol layer, a radio link control layer, and a medium access control layer.

The radio resource processing unit 211 generates, for example, downlink data, an RRC message, and a MAC control element to be placed on a physical downlink shared channel PDSCH, and outputs the downlink data, the RRC message, and the MAC control element to the transmitter 27. In addition, the radio resource processing unit 211 generates a control signal or control data to be placed on a physical downlink control channel PDCCH, and outputs the control signal or control data to the transmitter 27. Further, the radio resource processing unit 211 manages various types of configuration information of the terminal apparatus 10. The radio resource processing unit 211 executes start and stop of transmission and reception processing, start of a UL synchronization procedure (random access procedure), update of system information, adjustment of a beam transmission angle, cell configuration regarding handover, pre-configuration of a parameter regarding a measurement event type (measurement event identifier), and the like based on a notification by a signal or an RRC message from the terminal apparatus 10.

The discontinuous transmission and reception processing unit 213 executes a series of control processing related to discontinuous reception (DRX) and discontinuous transmission (DTX). For example, the discontinuous transmission and reception processing unit 213 performs management of a plurality of timers related to discontinuous reception (DRX) and discontinuous transmission (DTX), a series of transmission and reception processing of the base station apparatus 20 in the active period or the inactive period, and the like based on an instruction from the radio resource processing unit 211 or a notification by a signal or an RRC message from the terminal apparatus 10. The discontinuous transmission and reception processing unit 213 executes generation processing of a timer related to Cell DTX/DRX associated with discontinuous transmission and reception of the base station apparatus 20, a timer related to C-DRX associated with discontinuous transmission and reception of the connected terminal apparatus 10, and a timer related to retransmission control, control for coordination among the respective timers, and determination processing for scheduling for the terminal apparatus 10 based on a coordination result.

The controller 23 performs various types of control in the base station apparatus 20. For example, the controller 23 generates a control signal or control data for controlling the receiver 25 and the transmitter 27 based on the control information from the processing unit 21. In addition, the controller 23 controls downlink transmission to the terminal apparatus 10 and uplink reception from the terminal apparatus 10, respectively, based on determination information related to discontinuous transmission and reception received from the discontinuous transmission and reception processing unit 213.

The receiver 25 separates, demodulates, and decodes various signals received from the terminal apparatus 10 or the core network 30 via the transmission and reception antenna unit 29 based on the control signal provided from the controller 23. The receiver 25 outputs the decoded information to the processing unit 21.

The transmitter 27 generates, for example, a downlink reference signal based on the control signal provided from the controller 23. The transmitter 27 performs encoding, modulation, multiplexing, and the like on various types of information provided from the processing unit 21, thereby transmitting a signal to the terminal apparatus 10 via the transmission and reception antenna unit 29.

In addition, the transmitter 27 transmits data to the terminal apparatus 10, another base station apparatus 20, or the core network 30. The receiver 25 receives data from the terminal apparatus 10, another base station apparatus 20, or the core network 30.

Note that the processing unit 21 and the controller 23 are implemented by, for example, a processor system including a processor and a memory. In this case, the processor provides the functions of the processing unit 21 and the controller 23 by executing a program describing an operation of the base station apparatus 20 described below. In addition, the processing unit 21 and the controller 23 may be implemented by one processor system or may be implemented by a plurality of processor systems. Alternatively, the processing unit 21 and the controller 23 may be implemented by a DSP, a hardware circuit, or the like.

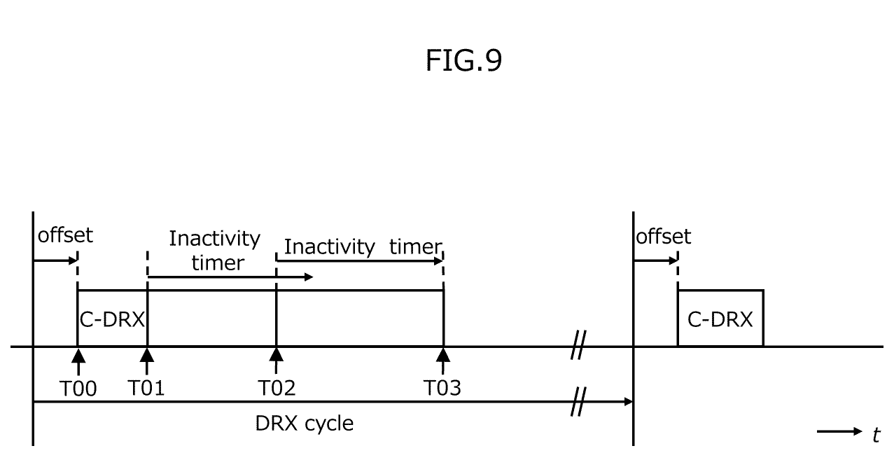

The DRX (also referred to as C-DRX or UE DRX) during related connection will be described with reference to FIGS. 9 to 11. FIG. 9 is a diagram illustrating an example of a control method of the active period and the inactive period of the terminal apparatus 10. A horizontal axis represents the passage of time. The active period indicates a period (zone or time) during which the terminal apparatus 10 monitors the PDCCH. That is, the active period indicates a monitoring period during which the terminal apparatus 10 attempts to decode a PDCCH scrambled (data-masked) with a predetermined radio network temporary identifier (RNTI). The RNTI that the terminal apparatus 10 attempts to decode is any one of a C-RNTI, a CI-RNTI, a CS-RNTI, an INT-RNTI, an SFI-RNTI, an SP-CSI-RNTI, a TPC-PUCCH-RNTI, a TPC-PUSCH-RNTI, a TPC-SRS-RNTI, an AI-RNTI, an SL-RNTI, an SLCS-RNTI, and an SL semi-persistent scheduling V-RNTI.

In addition, the terminal apparatus 10 stops periodic or quasi-periodic uplink transmission in the inactive period. Specifically, the terminal apparatus 10 stops reporting a sounding reference signal (SRS) and channel state information (CSI) in the inactive period.

For the terminal apparatus 10 of FIGS. 9 to 11, at least an offset (offset) indicating a start position of the active period (C-DRX active period), an on duration timer indicating a duration of the active period, and a DRX cycle indicating a repetition period of DRX are configured by the base station apparatus 20. These pieces of information are configured as DRX-related parameters by the base station apparatus 20 for the terminal apparatus 10 using an RRC message.

As illustrated in FIG. 9, the active period is started from a timing (time T00) at which an offset time from the head of a certain frame has elapsed. The terminal apparatus 10 starts running of the on duration timer (drx-onDurationTimer) from time T00, and a period in which the on duration timer is running is considered as the active period. Further, in a case where the physical downlink control channel PDCCH is received during running of the on duration timer and the PDCCH indicates notification of new data, the terminal apparatus 10 starts running of an inactivity timer (drx-InactivityTimer (Inactivity timer in FIG. 9)). The terminal apparatus 10 performs transmission and reception assuming that a period in which the inactivity timer is running is also the active period. That is, the terminal apparatus 10 considers that the active period is extended.

Time T01 indicates a timing at which the terminal apparatus 10 receives the PDCCH indicating the notification of the new data. At this time, the terminal apparatus 10 starts running of the inactivity timer (Inactivity timer) and also continues monitoring of the PDCCH. Time T02 indicates that the PDCCH indicating the notification of the new data is received again before the inactivity timer expires. At this time, the terminal apparatus 10 restarts the inactivity timer that is running at time T02. Time T03 indicates a timing at which the inactivity timer restarted at time T02 expires.

The terminal apparatus 10 considers that the active period expires at time T03 at which the inactivity timer expires, and shifts to the inactive period (C-DRX inactive period).

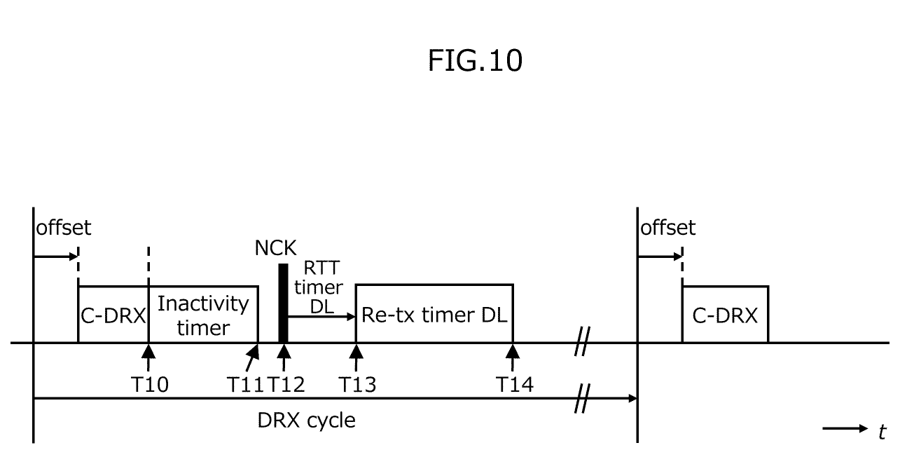

FIG. 10 is a diagram illustrating an example of a control method of the active period and the inactive period related to downlink data reception by the terminal apparatus 10. A horizontal axis represents the passage of time.

Similarly to FIG. 9, it is assumed that the terminal apparatus 10 receives the PDCCH at time T10 during the active period. At this time, in a case where downlink control information (DCI) obtained by decoding the PDCCH includes information (DL assignment) indicating a new downlink data reception resource, the terminal apparatus 10 starts running of the inactivity timer (Inactivity timer). The terminal apparatus 10 receives the physical downlink shared data channel PDSCH on the designated downlink data reception resource (not illustrated).

The terminal apparatus 10 transmits acknowledgement (ACK) indicating successful reception to the base station apparatus 20 in a case where the PDSCH is correctly received (decoding succeeds), and transmits a non-acknowledgement (NCK) indicating reception failure to the base station apparatus 20 in a case where the PDSCH is not correctly received (decoding fails) (time T12). The ACK or NCK is transmitted on a physical uplink control channel PUCCH or a physical uplink shared channel PUSCH. Although FIG. 10 illustrates a case where the inactivity timer expires at time T11, such a case is an example for simplifying the description, and time T12 may be earlier than time T11.

In a case where the NCK is transmitted at time T12, the terminal apparatus 10 starts a downlink HARQ round trip timer (drx-HARQ-RTT-TimerDL (RTT timer DL in FIG. 10)) from time T12, and in a case where the downlink HARQ round trip timer expires (time T13), the terminal apparatus 10 subsequently starts a downlink retransmission timer (drx-RetransmissionTimerDL (Re-Tx timer DL in FIG. 10)) for waiting for retransmission of downlink data from the base station apparatus 20.

Note that the terminal apparatus 10 considers a period in which the downlink retransmission timer is running as the active period. In a case where the DCI in a PDCCH received during monitoring while a downlink retransmission timer is running indicates retransmission of corresponding downlink data, the terminal apparatus 10 receives the retransmitted PDSCH and performs generation and transmission processing of an ACK or NCK based on a reception result of the received PDSCH. The terminal apparatus 10 repeats similar processing until the retransmitted downlink data is correctly received (not illustrated).

The downlink HARQ round trip timer and the downlink retransmission timer are configured as the DRX-related parameters by the base station apparatus 20 for the terminal apparatus 10 using an RRC message.

On the other hand, in a case where the ACK is transmitted at time T12, the terminal apparatus 10 starts the downlink HARQ round trip timer at time T12, but the downlink retransmission timer needs not be started in a case where the timer expires (time T13). In a case where the downlink retransmission timer expires (time T14), the terminal apparatus 10 considers that the active period has expired, and shifts to the inactive period (C-DRX inactive period).

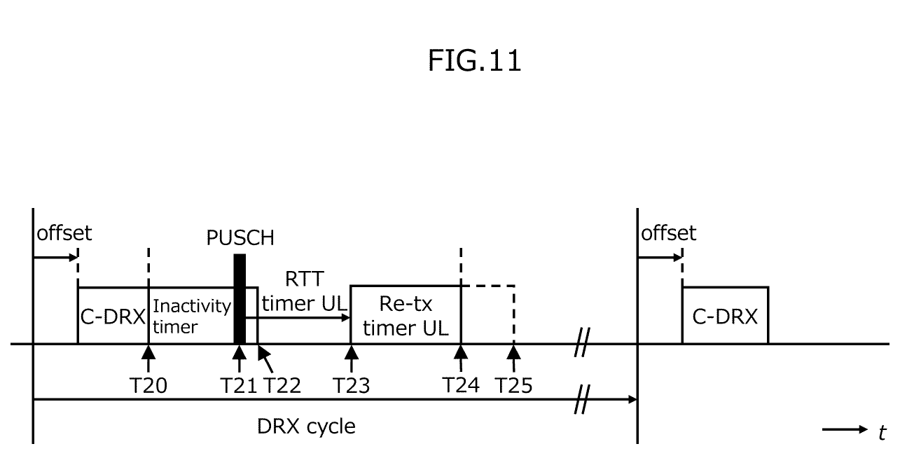

FIG. 11 is a diagram illustrating an example of a control method of the active period and the inactive period related to uplink data transmission by the terminal apparatus 10. A horizontal axis represents the passage of time.

Similarly to FIG. 9, it is assumed that the terminal apparatus 10 receives the PDCCH at time T20 during the active period. At this time, in a case where information indicating a new uplink data transmission resource is included (UL grant) in the downlink control information (DCI) obtained by decoding the PDCCH, the terminal apparatus 10 starts running of the inactivity timer (Inactivity timer). The terminal apparatus 10 transmits the physical uplink shared data channel PUSCH on a designated uplink data transmission resource (time T21). Although FIG. 11 illustrates a case where the inactivity timer expires at time T22, such a case is an example for simplifying the description, and time T22 may be later than time T21.

In a case where the PUSCH is transmitted at time T21, the terminal apparatus 10 starts an uplink HARQ round trip timer (drx-HARQ-RTT-TimerUL (RTT timer UL in FIG. 11)) from time T21, and in a case where uplink HARQ round trip timer expires (time T23), the terminal apparatus 10 subsequently starts an uplink retransmission timer (drx-RetransmissionTimerUL (Re-Tx timer UL in FIG. 11)) for waiting for the ACK/NCK corresponding to uplink data transmitted to the base station apparatus 20. Note that the terminal apparatus 10 considers a period in which the uplink retransmission timer is running as the active period. In a case where the DCI in the PDCCH monitored during running of the uplink retransmission timer indicates successful transmission (ACK) of the corresponding uplink data at time T24, the terminal apparatus 10 stops running of the uplink retransmission timer.

Further, in a case where the DCI in the PDCCH monitored during running of the uplink retransmission timer indicates retransmission of the corresponding uplink data at time T24, the terminal apparatus 10 retransmits the PUSCH by using an uplink resource allocated for the retransmission, stops running of the uplink retransmission timer, and starts the uplink HARQ round trip timer. The terminal apparatus 10 repeats similar processing (not illustrated) until the ACK is received from the base station apparatus 20 as an uplink data transmission result.

The uplink HARQ round trip timer and the uplink retransmission timer are configured as the DRX-related parameters by the base station apparatus 20 for the terminal apparatus 10 using an RRC message.

In a case where the uplink retransmission timer is stopped (time T24) or expires (time T25), the terminal apparatus 10 considers that the active period has expired, and shifts to the inactive period (C-DRX inactive period).

The terminal apparatus 10 acquires a synchronization signal/physical broadcast channel block SSB (SS/PBCH Block) and adjusts downlink synchronization using the SSB when connecting (accessing) to the base station apparatus 20. The SSB includes a synchronization signal and a physical broadcast channel (PBCH). The synchronization signal includes a primary synchronization signal (PSS) and a secondary synchronization signal (SSS). The base station apparatus 20 may transmit the SSB even in the inactive period.

The cell quality (received quality) is calculated by measuring a synchronization signal block (SSB, Synchronization Signal Block) or a channel state information reference signal (CSI-RS). The cell quality can be expressed by using any of reference signal received power (RSRP), reference signal received quality (RSRQ), received signal strength indicator (RSSI), signal to interference plus noise ratio (SINR), and path loss.

The terminal apparatus 10 adjusts uplink synchronization by using an individual timing advance (TA). The individual timing advance is individually reported by a random access response from the base station apparatus 20 in the random access procedure. Uplink synchronization is considered valid during running of a timing advance timer (TA Timer). The random access procedure is started in a case where the terminal apparatus 10 transmits a physical random access channel (PRACH). The terminal apparatus 10 may transmit the PRACH even in the inactive period in a case where the trigger condition is satisfied.

The terminal apparatus 10 triggers a scheduling request (SR) for requesting the base station apparatus 20 to allocate an uplink resource with the occurrence of the uplink data in the terminal apparatus 10 as a trigger, and transmits the SR to the base station apparatus 20 using the PUCCH. In a case where a PUCCH resource for SR transmission is not allocated, the terminal apparatus 10 may transmit the SR by using a PRACH.

The present embodiments will be described with reference to the drawings in consideration of the above matters. In the description of the present embodiments, when a specific description of a known function or configuration related to the present embodiments makes the gist of the present embodiments unclear, the detailed description thereof will be omitted.

### First Embodiment

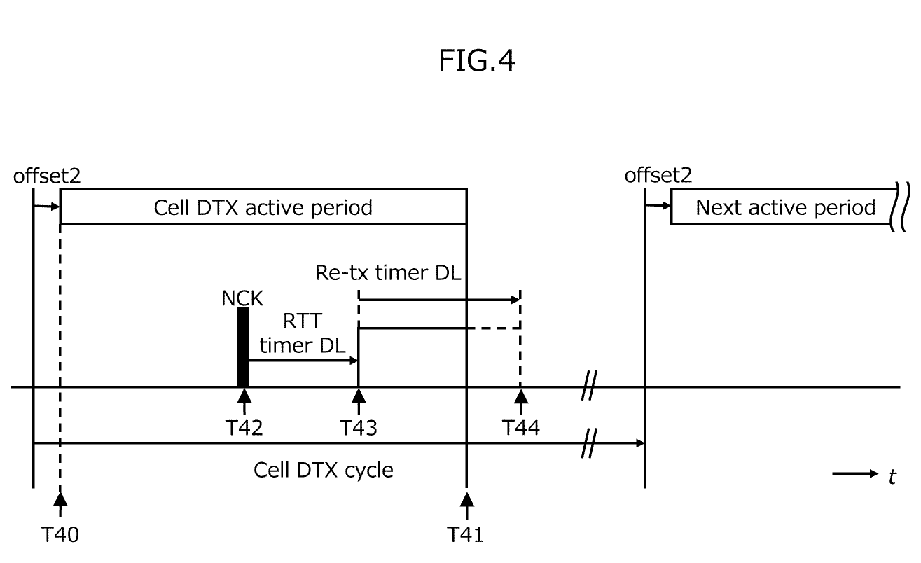

FIGS. 4 to 6 illustrate an example of a control method of an active period and an inactive period of the terminal apparatus 10 and the base station apparatus 20 according to a first embodiment, and a horizontal axis represents the passage of time. A PDCCH (or RNTI) monitored by the terminal apparatus 10 in the active period may be at least the same as in the related art. As for an uplink signal and an uplink channel for which the terminal apparatus 10 stops transmission in the inactive period, transmission of at least the same signal/channel as in the related art is stopped.

In FIGS. 4 to 6, for the terminal apparatus 10, at least an offset indicating a start position of the active period (C-DRX active period) of each terminal apparatus 10, an on duration timer indicating a duration of the active period, and a DRX cycle indicating a repetition cycle are configured by the base station apparatus 20.

In addition, as parameters indicating DTX on a cell basis (Cell DTX) or Cell DRX on a cell basis (Cell DRX), at least an offset (offset2) indicating a start position of a cell active period (Cell DTX active period or Cell DRX active period), a cell active period on duration timer (Cell DTX on duration timer or Cell DRX on duration timer) indicating a duration of the active period of Cell DTX or Cell DRX, and a Cell DTX cycle or Cell DRX cycle (Cell DTX cycle or Cell DRX cycle) indicating a repetition cycle are respectively configured.

The Cell DTX active period indicates a period during which the base station apparatus 20 is capable of transmitting dedicated signaling or dedicated data to the terminal apparatus 10, or a section in which the terminal apparatus 10 monitors a PDCCH in expectation of transmission of dedicated signaling or dedicated data from the base station apparatus 20. In addition, the Cell DRX active period indicates a period during which the base station apparatus 20 is capable of receiving dedicated signaling or dedicated data from the terminal apparatus 10, or a period during which the base station apparatus 20 is capable of receiving transmission of dedicated signaling or dedicated data from the terminal apparatus 10.

Hereinafter, in a case where there is no need to distinguish Cell DTX and Cell DRX, they are referred to as Cell DTX/DRX.

FIG. 4 is a diagram illustrating an example of a control method of the active period in a case where Cell DTX is configured. A horizontal axis represents the passage of time. It is assumed that the base station apparatus 20 notifies (configures or transmits) the terminal apparatus 10 of an active period (first active period) of Cell DTX, while not notifying a C-DRX configuration, and that an active period (hereinafter referred to as a C-DRX-related active period (second active period)) determined based on the C-DRX configuration is not configured.

The configuration of the C-DRX includes an offset, an on duration timer, a DRX cycle, an inactivity timer (drx-InactivityTimer), a downlink HARQ round trip timer (drx-HARQ-RTT-TimerDL), a downlink retransmission timer (drx-RetransmissionTimerDL), an uplink HARQ round trip timer (drx-HARQ-RTT-TimerUL), and an uplink retransmission timer (drx-RetransmissionTimerUL).

As illustrated in FIG. 4, the cell DTX active period on a cell basis (Cell DTX active period) is started from a timing (time T40) at which an offset (offset2) time from a predetermined timing has elapsed. The terminal apparatus 10 and the base station apparatus 20 start running a cell active period on duration timer for Cell DTX (cell dtx-onDurationTimer) from time T40. In addition, the terminal apparatus 10 and the base station apparatus 20 consider a case where the cell active period on duration timer for Cell DTX is running as an active period of Cell DTX, and consider a case where the cell active period on duration timer for Cell DTX expires (time T41) as an inactive period of Cell DTX. Note that the terminal apparatus 10 and the base station apparatus 20 consider that a state in which the cell active period on duration timer for Cell DTX is not running is also the Cell DTX deactivation period. The predetermined timing refers, for example, to a timing at a start or end time of a frame, a timing at a start or end time of a subframe, or a timing at a start or end time of a slot.

Here, as retransmission parameters for Cell DTX, the downlink HARQ round-trip timer for Cell DTX (cellDTX-HARQ-RTT-TimerDL) and the downlink retransmission timer for Cell DTX (cellDTX-RetransmissionTimerDL) (first retransmission timer) are configured from the base station apparatus 20 to the terminal apparatus 10. These pieces of timer information are included in a part of Cell DTX configuration, and are configured from the base station apparatus 20 to the terminal apparatus 10 using the RRC message. The RRC message is, for example, an RRC Reconfiguration message. The timer information can be commonly used for each HARQ.

The terminal apparatus 10 considers that the downlink data can be received in the cell DTX active period. Further, the terminal apparatus 10 considers that the downlink data can be received again in the cell DTX active period. The base station apparatus 20 considers that the downlink data can be transmitted in the cell DTX active period. Further, the base station apparatus 20 considers that the downlink data can be transmitted again in the cell DTX active period.

Time T42 indicates a timing at which the terminal apparatus 10 fails to correctly decode the PDSCH received during the Cell DTX active period and transmits a reception failure (NCK) to the base station apparatus 20.

In a case where an NCK is transmitted at time T42, the terminal apparatus 10 starts a downlink HARQ round-trip timer for Cell DTX (cellDTX-HARQ-RTT-TimerDL (RTT timer DL in FIG. 4)), and in a case where the downlink HARQ round-trip timer for Cell DTX expires (time T43), the terminal apparatus 10 subsequently starts a downlink retransmission timer for Cell DTX (cellDTX-RetransmissionTimerDL (Re-Tx timer DL in FIG. 4)) at time T43 to wait for retransmission of downlink data from the base station apparatus 20. The expiration (end) timing of the downlink retransmission timer for Cell DTX is time T44. Note that the base station apparatus 20 can perform new transmission even while the downlink HARQ round trip timer for Cell DTX is running.

That is, the base station apparatus 20 can transmit the PDCCH or can schedule and transmit the PDSCH while the downlink HARQ round trip timer for Cell DTX is running. In addition, the terminal apparatus 10 needs to monitor the PDCCH even while the downlink HARQ round trip timer for Cell DTX is running, and to attempt to receive the PDSCH when scheduled.

Here, as illustrated in FIG. 4, in a case where the active period of Cell DTX expires (ends) before the downlink retransmission timer for Cell DTX expires, the terminal apparatus 10 considers a period (between time T43 and time T44) in which the downlink retransmission timer for Cell DTX is running or a period (between time T41 and time T44) from the end of the active period of Cell DTX until the downlink retransmission timer expires as the active period (third active period). Alternatively, the terminal apparatus 10 may consider a period between time T41 and time T44 as a temporary extension period of the active period of Cell DTX.

In a case where the DCI in a PDCCH received during monitoring regarding a period considered as an active period while the downlink retransmission timer for Cell DTX is running indicates retransmission of corresponding downlink data, the terminal apparatus 10 is permitted to respectively receive the retransmitted PDSCH and to perform generation and transmission processing of an ACK or NCK based on a reception result of the received PDSCH. The terminal apparatus 10 repeats similar processing until the retransmitted downlink data is correctly received (not illustrated).

Further, in a case where the DCI in the PDCCH received between time T41 and time T44 indicates new downlink data, the terminal apparatus 10 may consider the downlink retransmission timer for Cell DTX as expiring (stopping) and the active period as ending.

That is, in a case where an expiration (end) timing of the downlink retransmission timer for Cell DTX is later than an expiration (end) timing of the active period of Cell DTX, the base station apparatus 20 is permitted to transmit a PDCCH that instructs retransmission to the terminal apparatus 10, regarding a portion of the period exceeding the expiration timing of the active period as an active period. Furthermore, the base station apparatus 20 may explicitly instruct the terminal apparatus 10 to expire (stop) the downlink retransmission timer for Cell DTX by transmitting a PDCCH instructing new transmission.

The terminal apparatus 10 may determine whether to consider a period between time T41 and time T44 (or between time T43 and time T44) as the active period or the inactive period based on the configuration information from the base station apparatus 20. For example, it may be determined whether the active period is considered based on information specified by the PDCCH or the MAC CE.

In a case where an active period (second active period) related to C-DRX is configured, the terminal apparatus 10 considers a period during which the downlink retransmission timer (second retransmission timer) is running as the active period.

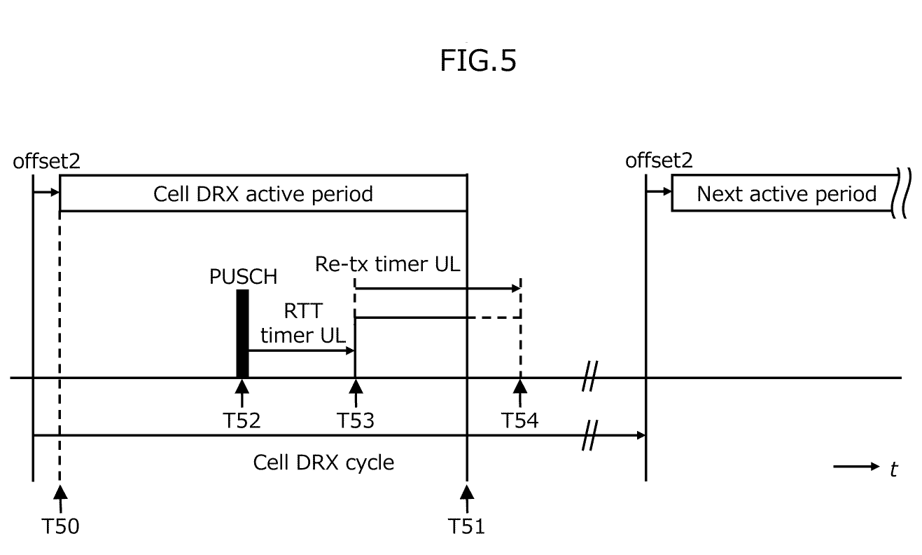

FIG. 5 is a diagram illustrating an example of a control method of the active period in a case where Cell DRX is configured. A horizontal axis represents the passage of time. It is assumed that the base station apparatus 20 notifies (configures or transmits) the terminal apparatus 10 of an active period (first active period) of Cell DRX, while not notifying a C-DRX configuration, and that an active period (second active period) related to C-DRX is not configured.

As illustrated in FIG. 5, the cell DRX active period on a cell basis (Cell DRX active period) is started from a timing (time T50) at which an offset (offset2) time from a predetermined timing has elapsed. The terminal apparatus 10 and the base station apparatus 20 start running a cell active period on duration timer for Cell DRX (cell drx-onDurationTimer) from time T50. In addition, the terminal apparatus 10 and the base station apparatus 20 consider a case where the cell active period on duration timer for Cell DRX is running as an active period of Cell DRX, and consider a case where the cell active period on duration timer for Cell DRX expires (time T51) as an inactive period of Cell DRX. Note that the terminal apparatus 10 and the base station apparatus 20 consider that a state in which the cell active period on duration timer for Cell DRX is not running is also the Cell DRX deactivation period. The predetermined timing refers, for example, to a timing at a start or end time of a frame, a timing at a start or end time of a subframe, or a timing at a start or end time of a slot.

Here, as retransmission parameters for Cell DRX, the uplink HARQ round trip timer for Cell DRX (cellDRX-HARQ-RTT-TimerUL) and the uplink retransmission timer for Cell DRX (cellDRX-RetransmissionTimerUL) (first retransmission timer) are configured from the base station apparatus 20 to the terminal apparatus 10. These pieces of timer information are included in a part of Cell DRX configuration, and are configured from the base station apparatus 20 to the terminal apparatus 10 using the RRC message. The RRC message is, for example, an RRC Reconfiguration message. The timer information can be commonly used for each HARQ.

The terminal apparatus 10 considers that the uplink data can be transmitted in the cell DRX active period. Further, the terminal apparatus 10 considers that the uplink data can be transmitted again in the cell DRX active period. The base station apparatus 20 considers that the uplink data can be received in the cell DRX active period. Further, the base station apparatus 20 considers that the uplink data can be received again in the cell DRX active period.

Time T52 indicates a timing at which the terminal apparatus 10 transmits the PUSCH scheduled in the active period of Cell DRX to the base station apparatus 20 according to the uplink resource allocation instruction (UL grant) by the PDCCH.

In a case where the PUSCH is transmitted at time T52, the terminal apparatus 10 starts the uplink HARQ round trip timer for Cell DRX (cellDRX-HARQ-RTT-TimerUL (RTT timer UL in FIG. 5)), and in a case where the uplink HARQ round trip timer for Cell DRX expires (time T53), the terminal apparatus 10 starts the uplink retransmission timer for Cell DRX (cellDRX-RetransmissionTimerUL (Re-Tx timer UL in FIG. 5)) at time T53 for waiting for an ACK/NCK corresponding to uplink data transmitted to the base station apparatus 20. The expiration (end) timing of the uplink retransmission timer for Cell DRX is time T54. Note that the base station apparatus 20 can cause the terminal apparatus 10 to perform new transmission even while the uplink HARQ round trip timer for Cell DRX is running.

That is, the base station apparatus 20 can also schedule transmission of the PUSCH while the uplink HARQ round trip timer for Cell DRX is running. In addition, in a case where uplink transmission is scheduled while the uplink HARQ round trip timer for Cell DRX is running, the terminal apparatus 10 needs to attempt transmission of the PUSCH.

Here, as illustrated in FIG. 5, in a case where the active period of Cell DRX expires (ends) before the uplink retransmission timer for Cell DRX expires, the terminal apparatus 10 considers a period (between time T53 and time T54) in which the uplink retransmission timer for Cell DRX is running or a period (between time T51 and time T54) from the end of the active period of Cell DRX until the uplink retransmission timer expires as the active period (third active period). Alternatively, the terminal apparatus 10 may consider a period between time T51 and time T54 as a temporary extension period of the active period of Cell DRX.

The terminal apparatus 10 monitors the PDCCH by regarding the running of the uplink retransmission timer for Cell DRX as an active period, and in a case where a PDCCH received during the monitoring indicates that the uplink data transmitted by the terminal apparatus 10 has failed to be received (NCK) at the base station apparatus 20, the terminal apparatus 10 is permitted to attempt retransmission of the PUSCH using the scheduled transmission resource. The terminal apparatus 10 repeats similar processing (not illustrated) until a transmission success (ACK) corresponding to the retransmitted uplink data is received.

Further, in a case where the DCI in the PDCCH received between time T51 and time T54 indicates new downlink data, the terminal apparatus 10 may consider the uplink retransmission timer for Cell DRX as expiring (stopping) and the active period as ending.

That is, in a case where an expiration (end) timing of the uplink retransmission timer for Cell DRX is later than an expiration (end) timing of the active period of Cell DRX, the base station apparatus 20 is permitted to transmit a PDCCH that instructs retransmission to the terminal apparatus 10, regarding a portion of the period exceeding the expiration timing of the active period as an active period. Furthermore, the base station apparatus 20 may explicitly instruct the terminal apparatus 10 to expire (stop) the uplink retransmission timer for Cell DRX by transmitting a PDCCH instructing new transmission.

The terminal apparatus 10 may determine whether to consider a period between time T51 and time T54 (or between time T53 and time T54) as the active period or the inactive period based on the configuration information from the base station apparatus 20. For example, it may be determined whether the active period is considered based on information specified by the PDCCH or the MAC CE.

In a case where an active period (second active period) related to C-DRX is configured, the terminal apparatus 10 considers a period during which the uplink retransmission timer (second retransmission timer) is running as the active period.

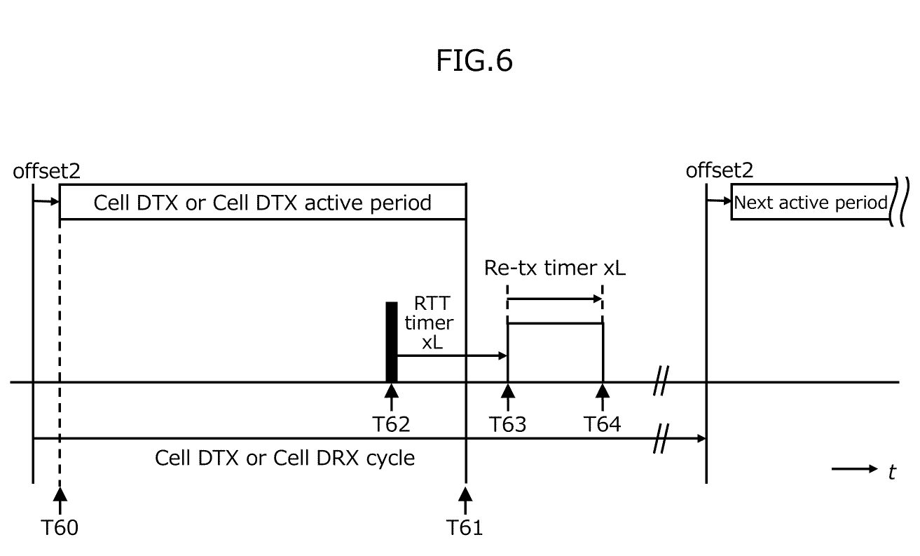

FIG. 6 is a diagram illustrating another example of the control method for the active period in FIG. 4 or FIG. 5. A horizontal axis represents the passage of time. It is assumed that the base station apparatus 20 does not notify (configure or transmit) the terminal apparatus 10 of the configuration of the C-DRX and the active period related to the C-DRX is not configured.

A timer RTT timer xL in FIG. 6 indicates either the downlink HARQ round trip timer for Cell DTX (cellDTX-HARQ-RTT-TimerDL) or the uplink HARQ round trip timer for Cell DRX (cellDRX-HARQ-RTT-TimerUL), which will be described in the text. Similarly, the timer Re-Tx timer xL in FIG. 6 indicates either the downlink retransmission timer for Cell DTX (cellDTX-RetransmissionTimerDL) or the uplink retransmission timer for Cell DRX (cellDRX-RetransmissionTimerUL), which will be described in the text. A configuration method for these pieces of information is described with reference to FIG. 4 or FIG. 5, and thus details thereof are omitted.

A modification example of FIG. 4 using FIG. 6 will be described. The DTX active period on a cell basis (Cell DTX active period) starts at a timing (time T60) when an offset (offset2) time has elapsed from a predetermined timing, and ends at an expiration timing (time T61) of a cell active period on duration timer for Cell DTX (cell dtx-onDurationTimer). The predetermined timing refers, for example, to a timing at a start or end time of a frame, a timing at a start or end time of a subframe, or a timing at a start or end time of a slot.

Time T62 indicates a timing at which the terminal apparatus 10 fails to correctly decode the PDSCH received during the Cell DTX active period and transmits a reception failure (NCK) to the base station apparatus 20. At this time, the terminal apparatus 10 determines whether the time (time T63) after the downlink HARQ round trip timer for Cell DTX (cellDTX-HARQ-RTT-TimerDL (RTT timer xL in FIG. 6)) elapses exceeds the expiration timing (time T61) of the Cell DTX active period, and in a case where the time exceeds the expiration timing, the terminal apparatus 10 starts running of the downlink retransmission timer (cellDTX-RetransmissionTimerDL (Re-Tx timer xL in FIG. 6)) after the time indicated by the downlink HARQ round trip timer for Cell DTX elapses. On the other hand, in a case where the time does not exceed the expiration timing, the terminal apparatus 10 does not run the downlink retransmission timer.

Alternatively, after transmitting a reception failure (NCK) to the base station apparatus 20, the terminal apparatus 10 determines whether a time (time T64) obtained by adding the downlink HARQ round trip timer for Cell DTX and the downlink retransmission timer for Cell DTX exceeds the expiration timing (time T61) of the active period of Cell DTX. In a case where it exceeds, the terminal apparatus 10 may start running of the downlink retransmission timer for Cell DTX after a time indicated by the downlink HARQ round trip timer for Cell DTX has elapsed. On the other hand, in a case where the time does not exceed the expiration timing, the terminal apparatus 10 does not have to run the downlink retransmission timer for Cell DTX.

In addition, the downlink HARQ round trip timer for Cell DTX may be omitted. After transmitting the reception failure (NCK) to the base station apparatus 20, the terminal apparatus 10 may start running of a timer of a predefined fixed value (for example, 4 ms) or may start running of a downlink retransmission timer for Cell DTX.

In a case where the DCI in a PDCCH received during monitoring regarding a period considered as an active period while the downlink retransmission timer for Cell DTX is running indicates retransmission of corresponding downlink data, the terminal apparatus 10 receives the retransmitted PDSCH and performs generation and transmission processing of an ACK or NCK based on a reception result of the received PDSCH. The terminal apparatus 10 repeats similar processing until the retransmitted downlink data is correctly received (not illustrated).

The base station apparatus 20 transmits, to the terminal apparatus 10, the PDCCH including scheduling information for retransmission regarding a period considered as an active period while a downlink retransmission timer for Cell DTX is running, and also transmits a PDSCH using a radio resource indicated by the PDCCH.

A modification example of FIG. 5 using FIG. 6 will be described. The DRX active period on a cell basis (Cell DRX active period) starts at a timing (time T60) when an offset (offset2) time has elapsed from a predetermined timing, and ends at an expiration timing (time T61) of a cell active period on duration timer for Cell DRX (cell drx-onDurationTimer). The predetermined timing refers, for example, to a timing at a start or end time of a frame, a timing at a start or end time of a subframe, or a timing at a start or end time of a slot.

Time T62 indicates a timing at which the terminal apparatus 10 transmits the PUSCH scheduled in the active period of Cell DRX to the base station apparatus 20. At this time, the terminal apparatus 10 determines whether the time (time T63) after the uplink HARQ round trip timer for Cell DRX (cellDRX-HARQ-RTT-TimerUL (RTT timer xL in FIG. 6)) elapses exceeds the expiration timing (time T61) of the Cell DRX active period, and in a case where the time exceeds the expiration timing, the terminal apparatus 10 starts running of the uplink retransmission timer (cellDRX-RetransmissionTimerUL (Re-Tx timer xL in FIG. 6)) after the time indicated by the uplink HARQ round trip timer for Cell DRX elapses. On the other hand, in a case where the time does not exceed the expiration timing, the terminal apparatus 10 does not have to run the uplink retransmission timer.

Alternatively, after transmitting the PUSCH to the base station apparatus 20, the terminal apparatus 10 determines whether a time (time T64) obtained by adding the uplink HARQ round trip timer for Cell DRX and the uplink retransmission timer for Cell DRX exceeds the expiration timing (time T61) of the Cell DRX active period. In a case where it exceeds, the terminal apparatus 10 may start running of the uplink retransmission timer for Cell DRX after a time indicated by the uplink HARQ round trip timer for Cell DRX has elapsed. On the other hand, in a case where the time does not exceed the expiration timing, the terminal apparatus 10 does not have to run the uplink retransmission timer for Cell DRX.

In addition, the uplink HARQ round trip timer for Cell DRX may be omitted. After transmitting the PUSCH to the base station apparatus 20, the terminal apparatus 10 may start running of a timer of a predefined fixed value (for example, 4 ms) or may start running of the uplink retransmission timer for Cell DRX.

The terminal apparatus 10 monitors the PDCCH by regarding the running of the uplink retransmission timer for Cell DRX as an active period, and in a case where a PDCCH received during the monitoring indicates that the uplink data transmitted by the terminal apparatus 10 has failed to be received (NCK) at the base station apparatus 20, the terminal apparatus 10 attempts retransmission of the PUSCH using the scheduled transmission resource. The terminal apparatus 10 repeats similar processing (not illustrated) until a transmission success (ACK) corresponding to the retransmitted uplink data is received.

The base station apparatus 20 generates and transmits the PDCCH indicating a reception result of the PUSCH transmitted from the terminal apparatus 10 regarding a period during which the uplink retransmission timer for Cell DRX is running as an active period. In addition, in a case of reception failure (NCK), the base station apparatus 20 generates the PDCCH including scheduling information for retransmission of the PUSCH to the terminal apparatus 10 and transmits the PDCCH to the terminal apparatus 10.

For the purpose of reducing the amount of signaling, the base station apparatus 20 may instruct the terminal apparatus 10 to reuse a retransmission parameter of Cell DTX (Cell DRX) as a retransmission parameter of Cell DRX (Cell DTX), or may explicitly or implicitly instruct the terminal apparatus 10 to apply values of common parameters to Cell DTX and Cell DRX, respectively.

As described above, according to the first embodiment, even in a cell to which Cell DTX/DRX is applied for power saving, since the terminal apparatus 10 and the base station apparatus 20 can instruct whether retransmission control is to be performed for each terminal apparatus 10, data can be transmitted and received efficiently while suppressing an increase in the power consumption of the base station apparatus 20. That is, it becomes possible to improve power saving efficiency related to radio communication between the terminal apparatus 10 and the base station apparatus 20.

### Second Embodiment

A second embodiment will be described. Note that the description of configurations, functions, or procedures common to the first embodiment and the second embodiment will be omitted. That is, points different from the first embodiment will be mainly described below.

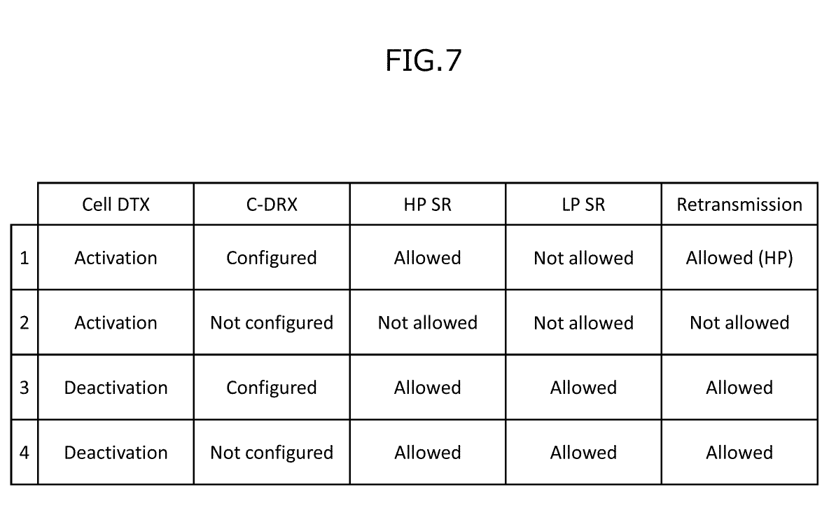

FIG. 7 is a diagram for illustrating an example of a determination method for a retransmission control method of the terminal apparatus 10 according to the present embodiment.

In FIG. 7, “Cell DTX” is an item that indicates whether the Cell DTX configuration configured for the terminal apparatus 10 is activated (valid), and “Activation” indicates the activated state, while “deactivation” indicates the deactivated state. Furthermore, in FIG. 7, “C-DRX” is an item that indicates whether the C-DRX configuration has been notified to the terminal apparatus 10, where “Configured” indicates a state in which the configuration has been notified, and “Not configured” indicates a state in which the configuration has not been notified.

“HP SR” or “LP SR” in FIG. 7 is an item that indicates whether the scheduling request (SR) is permitted. Here, “HP SR” refers to a high priority scheduling request (High priority SR), and “LP SR” refers to a low priority scheduling request (Low priority SR), and “Allowed” indicates a state in which transmission of the SR is permitted, and “Not allowed” indicates a state in which transmission of the SR is not permitted.

The terminal apparatus 10 determines that the SR is an HP SR in a case where a logical channel corresponding to data that triggered the SR has a high priority, and determines that the SR is an LP SR in a case where a logical channel corresponding to data that triggered the SR has a low priority. The terminal apparatus 10 may determine that the logical channel configuration in which a value equal to the resource index of the physical layer is configured as the priority is the high priority, may determine that the priority configuration of the logical channel configuration exceeds a preconfigured threshold value as the high priority, or may be individually configured from the RRC layer for each logical channel. Note that the high priority is an example of a first priority, and the low priority is an example of a second priority. Therefore, the first priority can be described as having a higher priority than the second priority.

The configuration information for determining the priority is configured in the terminal apparatus 10 by the base station apparatus 20. In a case where the configuration information regarding the priority is not notified, the terminal apparatus 10 may determine all the SRs as high priority, may determine all the SRs as low priority, or may be instructed by the base station apparatus 20 as to which of them to consider. Note that the configuration information for determining the priority is an example of the priority information.

In FIG. 7, “Retransmission” is an item that indicates whether retransmission of data corresponding to the SR is permitted in a case where the terminal apparatus 10 transmits the SR, “Allowed” indicates a state in which retransmission is permitted, and “Not allowed” indicates a state in which retransmission is not permitted. Note that this item may be considered as an item indicating whether retransmission of data corresponding to the HARQ process is permitted.

The terminal apparatus 10 controls transmission and reception processing related to retransmission based on determination as to whether to activate the Cell DTX configuration, whether to notify (configure) the C-DRX configuration, and whether to transmit a scheduling request (SR) based on the priority. More specifically, the terminal apparatus 10 performs the following determination regarding retransmission control. Note that “deactivation” of Cell DTX in FIG. 7 may be considered as indicating a state in which Cell DTX configurations are not configured for the terminal apparatus 10 (that is, “Not configured”).

For example, as illustrated in the row of “1” in FIG. 7, (a) in a case where the Cell DTX configuration is notified and activated, and (b) in a state where the C-DRX configuration is notified, the terminal apparatus 10 determines that retransmission of data corresponding to SR with high priority is permitted in the inactive period of Cell DTX and the active period related to retransmission of C-DRX, and determines that retransmission of data corresponding to SR with low priority is not permitted in the inactive period of Cell DTX.

Similarly, as illustrated in the row of “2” in FIG. 7, (a) in a case where the Cell DTX configuration is notified and activated, and (b) in a state where the C-DRX configuration is not notified, the terminal apparatus 10 determines that retransmission of data corresponding to the SR is not permitted in the inactive period of the Cell DTX regardless of whether the priority is configured.

Similarly, as illustrated in the row of “3” in FIG. 7, (a) in a case where the Cell DTX configuration is notified and is not activated, and (b) in a state where the C-DRX configuration is notified, the terminal apparatus 10 determines that retransmission of data corresponding to the SR is permitted during an inactive period of Cell DTX and an active period related to retransmission of C-DRX, regardless of whether the priority is configured.

Similarly, as illustrated in the row of “4” in FIG. 7, (a) in a case where the Cell DTX configuration is notified and is not activated, and (b) in a state where the C-DRX configuration is not notified, the terminal apparatus 10 determines that retransmission of data corresponding to the SR is permitted during an inactive period of Cell DTX and an active period related to retransmission of C-DRX, regardless of whether the priority is configured.

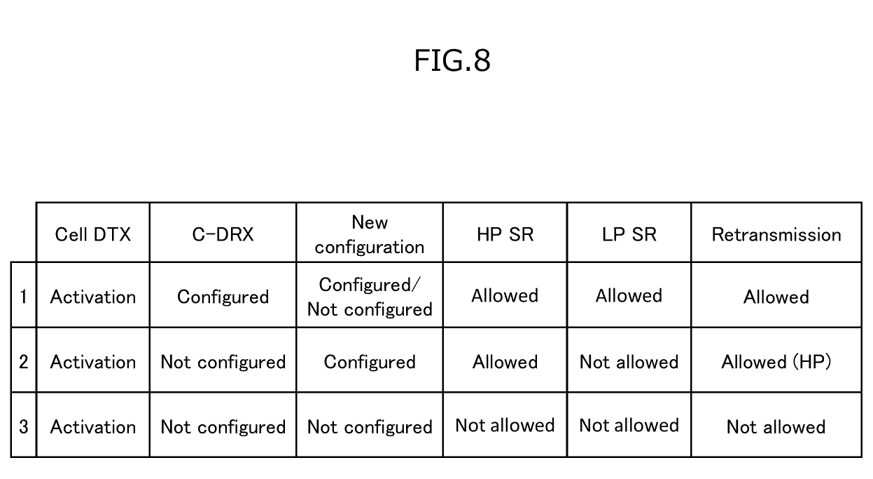

FIG. 8 is a diagram for illustrating another example of a determination method for a retransmission control method of the terminal apparatus 10 according to the present embodiment. “New configuration” in FIG. 8 indicates a parameter (that is, the retransmission parameter of Cell DTX or the retransmission parameter of Cell DRX, or both of them) for enabling retransmission of data in a case where the C-DRX configuration is not notified.

The terminal apparatus 10 controls transmission and reception processing related to retransmission based on determination as to whether to activate the Cell DTX configuration, whether to notify (configure) the C-DRX configuration, whether to notify (configure) parameters related to retransmission of data, and whether to transmit a scheduling request (SR) based on the priority. More specifically, the terminal apparatus 10 performs the following determination regarding retransmission control.

For example, as illustrated in the row of “1” in FIG. 8, (a) in a case where the Cell DTX configuration is notified and activated, and (b) in a state where the C-DRX configuration is notified, the terminal apparatus 10 determines that retransmission of data corresponding to the SR is permitted during an inactive period of Cell DTX and an active period of C-DRX, regardless of the presence or absence of parameters related to retransmission of data. That is, the terminal apparatus 10 determines whether retransmission is possible without checking a timer related to retransmission of Cell DTX or Cell DRX.

Similarly, as illustrated in the row of “2” in FIG. 8, (a) in a case where the Cell DTX configuration is notified and activated, (b) in a case where the C-DRX configuration is not notified, and (c) in a state where the parameter related to data retransmission is notified, the terminal apparatus 10 determines that retransmission of data corresponding to SR with high priority is permitted in the inactive period of the Cell DTX and the period in which the timer related to Cell DTX or Cell DRX retransmission is running, and determines that retransmission of data corresponding to SR with low priority is not permitted in the inactive period of Cell DTX.

Similarly, as illustrated in the row of “3” in FIG. 8, (a) in a case where the Cell DTX configuration is notified and activated, (b) in a case where the C-DRX configuration is not notified, and (c) in a state where the parameter related to the retransmission of the data is not notified, the terminal apparatus 10 determines that the retransmission of the data corresponding to the SR is not permitted in the inactive period of the Cell DTX regardless of the presence or absence of the priority configuration.

Note that, in a case where the Cell DTX configuration is inactive or is not notified, the parameter related to data retransmission does not operate, and thus, the terminal apparatus 10 may determine the operation according to the configuration in the row of “3” or “4” in FIG. 7 without checking the timer (first retransmission timer) related to the retransmission of Cell DTX or Cell DRX.

The terminal apparatus 10 may receive an instruction of dynamic activation (deactivation) from the base station apparatus 20 by an L1 message or an L2 message from the state where the Cell DTX/DRX configuration is deactivated (activated). For example, the base station apparatus 20 may use a PDCCH scrambled (data masked) using a group-shared RNTI or may use an individual or shared MAC CE as an activation (deactivation) instruction. In a case where the MAC CE is used, the MAC CE may include only the LCH identifier.

In a case where at least Cell DTX configuration has been notified from the base station apparatus 20 and deactivation of Cell DTX in an activated state is instructed and in a case where a timer related to retransmission of the Cell DTX (first retransmission timer) is running, the terminal apparatus 10 stops both a cell active period on duration timer for Cell DTX and the timer related to retransmission of Cell DTX at the same time, without checking the presence or absence of each stopped timer, and may determine that retransmission of downlink is permitted at a subsequent timing.

In addition, in a case where at least Cell DTX configuration has been notified from the base station apparatus 20 and deactivation of Cell DRX in an activated state is instructed and in a case where a timer related to retransmission of the Cell DRX (first retransmission timer) is running, the terminal apparatus 10 stops both a cell active period on duration timer for Cell DRX and the timer related to retransmission of Cell DRX at the same time, without checking the presence or absence of each stopped timer, and may determine that retransmission of uplink is permitted at a subsequent timing.

In a case where the base station apparatus 20 configures a plurality of Cell DTX/DRX configurations for the terminal apparatus 10, a different timer for retransmission of Cell DTX may be configured for each Cell DTX configuration, or a timer for retransmission of one Cell DTX may be applied to a plurality of Cell DTX configurations. Similarly, a different timer for retransmission of Cell DRX may be configured for each Cell DRX configuration, or a timer for retransmission of one Cell DRX may be applied to a plurality of Cell DRX configurations. Even in a case where the Cell DTX/DRX configuration is dynamically switched to a different configuration, if a timer regarding cell DTX retransmission, a timer regarding cell DRX retransmission, or a retransmission timer regarding C-DRX is running, the terminal apparatus 10 may continue the data retransmission processing until the timer expires regardless of a newly applied Cell DTX/DRX configuration.

Note that, in a case where a measurement event (measurement evaluation) linked to a measurement configuration (measurement identifier) related to the power saving mode is configured to the terminal apparatus 10, the data retransmission processing may be stopped at the start or end of the evaluation of the measurement event. Alternatively, the terminal apparatus 10 may stop the data retransmission processing at the handover execution timing.

At this time, the base station apparatus 20 may configure a time-based event condition T1 (conditional event-T1) as an event condition (conditional handover configuration) for giving a notification of start of evaluation of a measurement event, or may newly give a notification of offset time information configured for the event condition T1. The offset time information is applied to the event establishment condition, and the terminal apparatus 10 may delay the timing of determining that the event has been established from the related specified time by a specified offset time.

As described above, according to the second embodiment, even in a cell to which Cell DTX/DRX is applied for power saving, since the terminal apparatus 10 and the base station apparatus 20 can determine whether retransmission control is to be performed for each terminal apparatus 10, data can be transmitted and received efficiently while suppressing an increase in the power consumption of the base station apparatus 20.

Furthermore, according to the first and second embodiments, in a cell to which Cell DTX/DRX is applied as a technology for network energy savings, the terminal apparatus 10 and the base station apparatus 20 can efficiently transmit and receive data while suppressing an increase in power consumption of the base station apparatus 20. That is, the terminal apparatus 10 and the base station apparatus 20 can improve power saving efficiency related to radio communication between the terminal apparatus 10 and the base station apparatus 20.

Note that each of the above-described present embodiments is for facilitating understanding of the present embodiment, and is not intended to limit the present embodiment. The present embodiment can be modified and improved without departing from the gist thereof, and the present embodiment includes equivalents thereof.

### Hardware Configuration of Each Apparatus in Each Embodiment

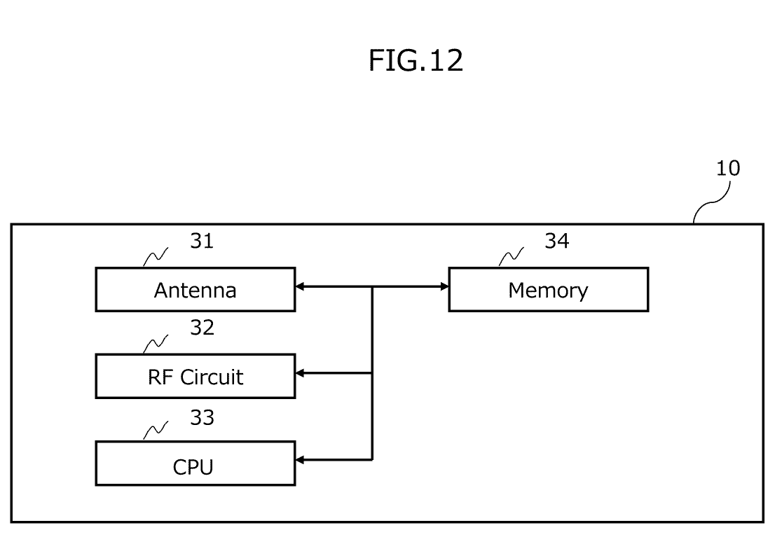

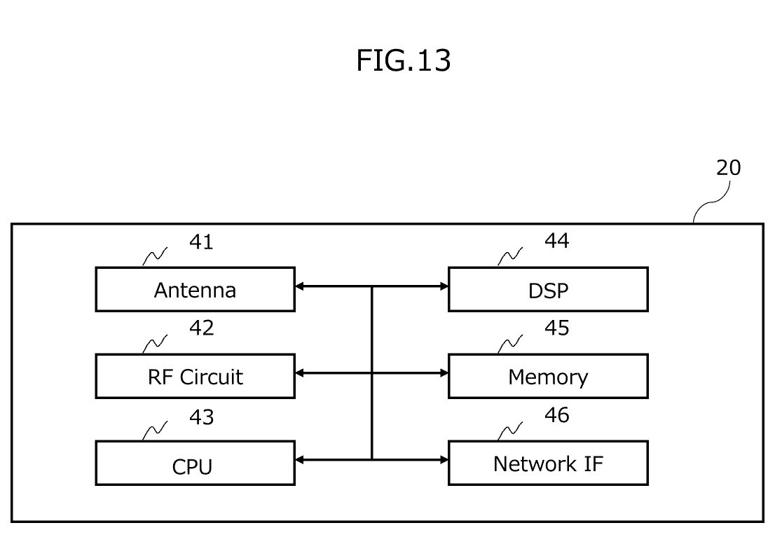

A hardware configuration of each apparatus in the radio communication system of each embodiment will be described with reference to FIGS. 12 and 13.

FIG. 12 is a diagram illustrating an example of a hardware configuration of the terminal apparatus 10. As illustrated in FIG. 12, the terminal apparatus 10 includes, for example, a radio frequency (RF) circuit 32 including an antenna 31, a central processing unit (CPU) 33, and a memory 34 as hardware components. Furthermore, the terminal apparatus 10 may include a display apparatus such as a liquid crystal display (LCD) connected to the CPU 33. The memory 34 includes, for example, at least one of a Random Access Memory (RAM) such as a Synchronous Dynamic Random Access Memory (SDRAM), a Read Only Memory (ROM), and a flash memory, and stores a program, control information, and a data signal.

The correspondence between the functional configuration of the terminal apparatus 10 illustrated in FIG. 2 and the hardware configuration of the terminal apparatus 10 illustrated in FIG. 12 will be described. The transmission and reception antenna unit 19, the transmitter 17, and the receiver 15 are implemented by, for example, the RF circuit 32, or the antenna 31 and the RF circuit 32. The controller 13 and the processing unit 11 are implemented by, for example, the CPU 33, the memory 34, a digital electronic circuit (not illustrated), and the like. For example, examples of the digital electronic circuit include an Application Specific Integrated Circuit (ASIC), a Field Programmable Gate Array (FPGA), and a Large Scale Integration (LSI).

FIG. 13 is a diagram illustrating an example of a hardware configuration of the base station apparatus 20. As illustrated in FIG. 13, the base station apparatus 20 includes, for example, an RF circuit 42 including an antenna 41, a CPU43, a DSP44, a memory 45, and a network interface (IF) 46 as hardware components. The CPU 43 is connected via a bus so as to be able to input and output various signals and data signals. The memory 45 includes, for example, at least one of a RAM such as an SDRAM, a ROM, and a flash memory, and stores a program, control information, and a data signal.

The correspondence between the functional configuration of the base station apparatus 20 illustrated in FIG. 3 and the hardware configuration of the base station apparatus 20 illustrated in FIG. 13 will be described. The transmission and reception antenna unit 29, the transmitter 27, and the receiver 25 are implemented by, for example, the RF circuit 42, or the antenna 41 and the RF circuit 42. The controller 23 and the processing unit 21 are implemented by, for example, the CPU 43, the DSP 44, the memory 45, a digital electronic circuit (not illustrated), and the like. Examples of the digital electronic circuit include an ASIC, an FPGA, and an LSI.

Throughout the descriptions, the indefinite article "a" or "an" does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

According to the above aspect, it is possible to provide a method for improving power saving efficiency related to radio communication between a terminal apparatus and a base station apparatus when applying a technology for network energy savings.

What is claimed is:

1. A terminal apparatus that communicates with a base station apparatus, the terminal apparatus comprising:
a receiver configured to receive, from the base station apparatus, first information regarding configuration of a first period indicating a period in which transmission and reception are possible on a cell basis, and second information regarding configuration of a second period indicating a period of discontinuous reception of the terminal apparatus; and
a controller configured to control transmission and reception in accordance with the first period and the second period, wherein
the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and
the controller performs processing of receiving retransmission of downlink data in accordance with the first configuration and the configuration of the second period, in a case where the first configuration is configured and activated and the second period is configured.

2. The terminal apparatus according to claim 1, wherein the first period is activated or deactivated by a PDCCH scrambled with a common identifier shared among a plurality of terminal apparatuses including the terminal apparatus.

3. The terminal apparatus according to claim 1, wherein the common parameter includes an offset indicating a start position of an active period of the first configuration and the second configuration, an on duration timer indicating a length of the active period, and information indicating a repetition period of the active period.

4. The terminal apparatus according to claim 1, wherein
the controller controls to monitor a PDCCH that instructs retransmission in a section during which either an on duration timer corresponding to the first configuration or a retransmission timer corresponding to the second period is running, in a case where the first configuration is configured and activated and the second period is configured.

5. The terminal apparatus according to claim 1, wherein
the controller performs retransmission processing of uplink data based on the second configuration, in a case where the second configuration is configured and activated and the second period is not configured.

6. The terminal apparatus according to claim 5, wherein
the controller performs retransmission of scheduled uplink data in a section during which an on duration timer corresponding to the second configuration is running, in a case where the second configuration is configured and activated and the second period is not configured.

7. A base station apparatus that communicates with a terminal apparatus, the base station apparatus comprising:
a transmitter configured to transmit, to the terminal apparatus, first information regarding configuration of a first period indicating a period in which transmission and reception are possible on a cell basis, and second information regarding configuration of a second period indicating a period of discontinuous reception of the terminal apparatus; and
a controller configured to control transmission and reception in accordance with the first period and the second period, wherein
the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and
the controller performs retransmission processing of downlink data in accordance with the first configuration and the configuration of the second period, in a case where the first configuration is configured and activated and the second period is configured.

8. The base station apparatus according to claim 7, wherein the first period is activated or deactivated by a PDCCH scrambled with a common identifier shared among a plurality of terminal apparatuses including the terminal apparatus.

9. The base station apparatus according to claim 7, wherein the common parameter includes an offset indicating a start position of an active period of the first configuration and the second configuration, an on duration timer indicating a length of the active period, and information indicating a repetition period of the active period.

10. The base station apparatus according to claim 7, wherein the controller performs processing for receiving retransmission of uplink data based on the second configuration, in a case where the second configuration is configured and activated and the second period is not configured.

11. The base station apparatus according to claim 10, wherein the controller controls to transmit a PDCCH indicating retransmission in a section during which either an on duration timer corresponding to the first configuration or a retransmission timer corresponding to the second period is running, in a case where the first configuration is configured and activated and the second period is configured.

12. The base station apparatus according to claim 10, wherein the controller performs processing for receiving retransmission of scheduled uplink data in a section during which an on duration timer corresponding to the second configuration is running, in a case where the second configuration is configured and activated and the second period is not configured.

13. A computer-implemented control method for a terminal apparatus that communicates with a base station apparatus, the computer-implemented control method comprising:
receiving, from the base station apparatus, first information regarding configuration of a first period indicating a period in which transmission and reception are possible on a cell basis, and second information regarding configuration of a second period indicating a period of discontinuous reception of the terminal apparatus, and
controlling transmission and reception in accordance with the first period and the second period, wherein
the first period is configured to configure one or both of a first configuration indicating a section in which the base station apparatus is capable of transmission, and a second configuration indicating a section in which the base station apparatus is capable of reception, and a value of a common parameter is applied to each of the first configuration and the second configuration, and
receiving retransmission of downlink data is performed in accordance with the first configuration and the configuration of the second period in a case where the first configuration is configured and activated and the second period is configured.
